(19) United States
(12) Patent Application Publication
(10) Pub. No.: US 2006/0226132 A1
(43) Pub. Date: Oct. 12, 2006

(54) Welding torch with enhanced cooling

(76) Inventor: William R. Giese, Beecher, IL (US)

Correspondence Address: Patrick S. Yoder;FLETCHER YODER, P.O. Box 692289, Houston, TX, 77269-2289, US

(21) Appl. No.: 11/102,442

(22) Filed: Apr. 8, 2005

(51) Int. Cl. B23K 9/173

(52) U.S. Cl. 219/137.31

(57) ABSTRACT

In accordance with one embodiment, the present invention relates to a welding torch. The welding torch includes a first hollow member through which wire electrode is routed and that has a plurality of protrusions that extend from an inner surface thereof. Advantageously, these protrusions of the exemplary welding torch increase the surface area of the first hollow member, and increasing the surface area improves the ability of the welding torch to dissipate heat to the surrounding environment, for instance.

### BACKGROUND

The present invention relates generally to welding devices and, more specifically, to apparatus and methods for cooling welding torches.

A common metal welding technique employs the heat generated by electrical arcing to transition workpieces to a molten state. One technique that employs this arcing principle is wire-feed welding. At its essence, wire-feed welding involves routing current from a power source and into an electrode that is brought into close proximity with the workpieces. When close enough, current arcs from the electrode to the workpieces, completing a circuit and generating sufficient heat to weld the workpieces to one another. Often, the electrode is consumed and becomes part of the weld itself.

To prevent the ingress of impurities into the molten weld, a flow of shielding material is typically provided around the weld location. By way of example, inert shielding gas is routed from a gas source and through the welding cable, and, at its conclusion, directed circumferentially around the weld location. This technique is often referred to in the industry as gas metal arc welding (GMAW or MIG).

Regardless of the wire-feed technique employed, routing electrical current from the power source to the electrode generates heat. Indeed, routing electrical current through conductive components in the welding torch (which is sometimes referred to as a “welding gun”) of a welding device, for instance, generates resistive heating. Unfortunately, such unwanted heating can negatively impact the performance and life span of the welding device. For example, resistive heating can lead to the degradation of the conductors and conductive elements within the welding torch. Also, generated heat may be transmitted to the environment surrounding the welding device, leading to unwanted and undesirable consequences.

Accordingly, there exists a need for improved welding devices and, more particularly, a need for improved apparatus and methods for cooling welding torches.

### BRIEF DESCRIPTION

In accordance with one exemplary embodiment, the present invention provides a welding torch that presents beneficial cooling properties. To increase the efficacy of cooling, the exemplary welding torch includes a hollow member that has a plurality of protrusions that at least partially define passageways that generally extend in the direction of the hollow member's longitudinal axis. Advantageously, these protrusions increase the surface area of the hollow member, providing a larger area through which heat developed in the welding torch may be dissipated. Additionally, in the event that a shielding gas is employed, the shielding gas can be routed through the passageways, further increasing the efficacy of cooling within the welding torch.

As another exemplary embodiment, the present invention provides a welding torch through which wire electrode is payed out. The exemplary welding torch includes a liner that has an interior volume through which wire electrode is routed. The exemplary torch also includes a tube, wherein the liner is disposed radially inboard of an inside peripheral surface of the tube. To improve the efficacy of cooling, for instance, the inside peripheral surface has a greater surface area than if the inside peripheral surface were circular in cross-section, the cross-section being taken transverse to the longitudinal axis of the tube. An increase in the inside peripheral surface area, as one example, is effectuated by providing ribs that extend radially inward and along the length of the tube. Advantageously, these ribs define interstices through which cooling fluid is routed.

Of course, the foregoing brief descriptions are merely representative of exemplary embodiments of the present invention, and, as such, the appended claims are not to be limited to these representative embodiments.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a robotic welding system, in accordance with an exemplary embodiment of the present invention;

FIG. 2 is an exploded, perspective view of a welding torch of the robotic welding system of FIG. 1;

FIG. 3 is cut, perspective view a neck assembly of the welding torch of FIG. 2; and

FIG. 4 is a cross-sectional view of the neck assembly of FIG. 3 along line 4-4.

### DETAILED DESCRIPTION

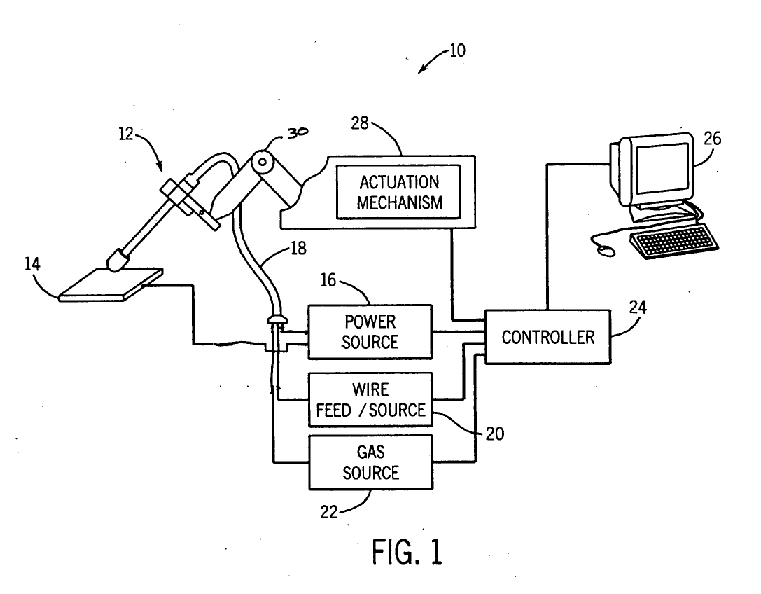

Turning to the figures, FIG. 1 illustrates an exemplary gas shielded and wire-feed robotic welding system 10. Prior to continuing, however, it is worth noting that the following discussion merely relates to exemplary embodiments of the present invention. As such, the appended claims should not be viewed as limited to those embodiments discussed herein. Indeed, the present invention provides benefits to both robotic and non-robotic welding systems as well as to both shielded and non-shielded welding devices. In summary, the prevention invention, which, in a general sense, relates to improved cooling and flow apparatus and methods, is applicable to a vast number of welding systems and devices, for instance.

Returning to the exemplary welding system 10, it includes a welding torch 12 that defines the location of the welding operation with respect to a workpiece 14. Specifically, placement of the welding torch 12 at a location proximate to the workpiece 14 allows current, which is provided by a power source 16 and which is routed to the welding torch 12 via a welding cable 18, to arc from the welding torch 12 to the workpiece 14. In summary, this arcing completes a circuit from the power source 16, to the welding torch 12 via the welding cable 18, to the workpiece 14, and, at its conclusion, back to the power source 16, generally to Ground. Advantageously, this arcing generates a relatively large amount of heat that causes the workpiece to transition to a molten state, facilitating the weld.

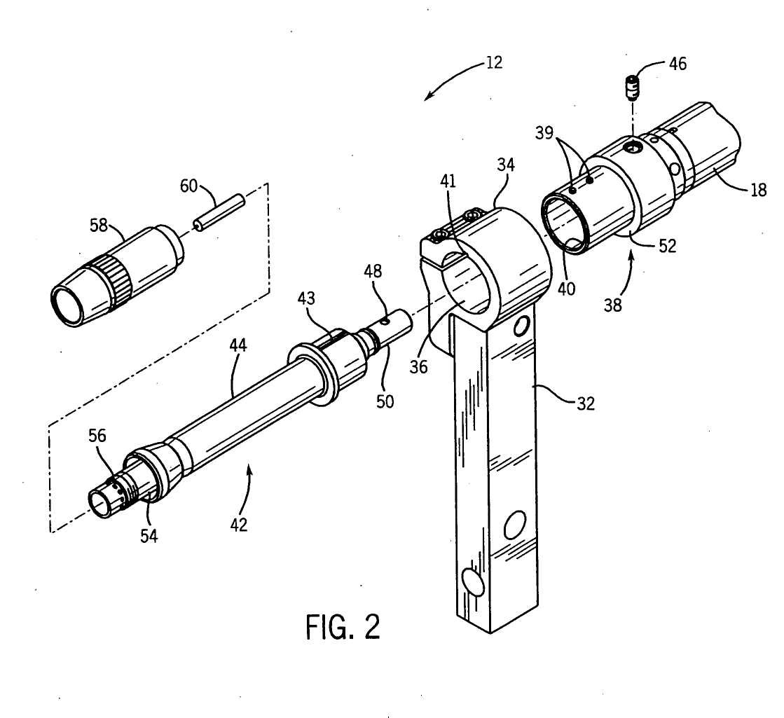

To produce electrical arcing, the exemplary system 10 includes a wire feeder 20 that provides a consumable wire electrode to the welding cable 18 and, in turn, to the welding torch 12. As discussed further below, the welding torch 12 routes electrical current to the wire electrode via a contact tip (see FIG. 2), leading to arcing between the egressing wire electrode and the workpiece 14.

To shield the weld area from contaminants during welding and to enhance arc performance, the exemplary system 10 includes a gas source 22 that feeds an inert, shielding gas to the welding torch 12 via the welding cable 18. As discussed in further detail below, the welding torch 12 directs the gas about the weld location. It is worth noting, however, that a variety of shielding materials, including various fluids and particulate solids, may be employed to protect the weld location. Moreover, the present invention is equally applicable to welding techniques in which a shielding material is not employed.

The exemplary system 10 also includes at least one controller 24 to manage the various functions and operations of the system 10. Types of controllers 24 include programmable logic circuits (PLCs), state switches, microprocessors, among other devices. The controller 24 receives inputs from the various components of the system 10 (e.g., welding torch 12, power source 16, wire feeder 20, and gas source 22) and provides appropriate responses to these components. For communications with a user, the controller 24 is coupled to a user interface 26. The user interface 26 displays information received by the controller 24, assisting a user in setting various operational parameters for the system 10, for example. Indeed, a user may directly control (i.e., provide command instructions to) the system 10 via the user interface 26.

The controller 24 also manages the operation of an actuation mechanism 28 that positions the welding torch 12 with respect to workpiece 14, thereby controlling the location of the weld. By way of example, the actuation mechanism 28 comprises a hydraulically-actuated robotic arm 30, which is capable of articulating in many directions. The robotic arm's 30 the pattern of movement may be defined by a programmed routine stored in the controller 24 and entered via the user interface 26, for instance.

Turning to FIG. 2, this figure illustrates an exploded, perspective view of the above-described welding torch 12. The welding torch 12 includes a mounting arm 32 that is securable to the robotic arm 30 (see FIG. 1) via a fastening mechanism, such as a bolt assembly or a screw. The mounting arm 32 carries a coupling member 34 that includes a receiving chamber 36 extending axially through the coupling member 34. The receiving chamber 36 is defined by an arcuate surface that matches the curvature of an external surface of a welding cable nipple 38. As illustrated in FIG. 2, the welding cable 18 is attached to one end of the nipple 38, and the opposite end is inserted into the receiving chamber 36 of the coupling member 34. By inserting the cable nipple 38 into the receiving chamber 36, the welding cable 18 can be secured to the welding arm 32. Indeed, screw members located on the coupling assembly 34 are tightened, causing the receiving chamber 36 to reduce in diameter and clamp with respect to the cable nipple 38. Advantageously, to prevent rotation of the cable nipple 38 with respect to the coupling assembly 34, and for proper alignment of the cable nipple 38 with respect to the coupling assembly 34, a pair of alignment pins 39 that extend through a wall of the cable nipple 38 are aligned with and inserted into a corresponding keyway 41 located in the receiving chamber 36.

The cable nipple 38, once inserted into the coupling assembly 34, further receives a neck assembly 42, to secure the neck assembly 42 to the mounting arm 32. Specifically, a sleeve 40 of the cable nipple 38 receives the neck assembly 42. Once the neck assembly 42 is inserted, the cable nipple 38 not only facilitates securement of the neck assembly 42 to the mounting arm 32, it also facilitates coupling of the welding cable 18 and the neck assembly 42 to one another. As discussed further below, welding resources, such as electrical current, wire electrode, and shielding gas, are routed through the welding cable 18 and provided to the neck assembly 42 via the nipple 38. In turn, the neck assembly 42 provides and directs these resources to the desired weld location.

Advantageously, the welding torch 12 includes features that aid in installation and alignment of the neck assembly 42 with respect to the remainder of the welding torch 12. For example, a keyway 43 located on an outer tube 44 of the of the neck assembly 42 mates with the alignment pins 39 of the cable nipple 38, thereby locking the angular position of the neck assembly 42 and the cable nipple 38 with respect to one another. (As discussed above, the keyway 41 in the coupling member 34 mates with the pins 39 of the nipple 38, thereby fixing the angular position of the coupling member 34 and the nipple 38. Thus, the neck assembly, the nipple, and the coupling member 34 cannot pivot with respect to one another once assembled.) Additionally, the exemplary welding torch 12 includes a set-screw 46 that is received by and that extends through the cable nipple 38. Specifically, the set-screw 46 engages with a notch 48 located on the external surface of an inner tube 50 of the neck assembly 42, which is discussed further below. This engagement between the set-screw 46 and the notch 48 prevents axial separation of the neck assembly 42 and the cable nipple 38 with respect to one another. Moreover, with the clamped relationship between the coupling member 34 and the cable nipple 38 in mind, the engagement of the set-screw 46, along with the abutment between a central flange 52 of the cable nipple 38 and the coupling member 34, cooperate to prevent axial separation of the neck assembly 42, coupling member 34, and cable nipple 38 with respect to one another.

The neck assembly 42, at the end away from and opposite to the coupling member 34, carries various features for delivering welding resources (e.g., electrical current, shielding gas, and wire electrode) to the weld location. For example, the neck assembly 42 carries a diffuser 54. In the exemplary welding torch 12, the diffuser 54 receives shielding gas from the inner tube 50, and this received gas is routed through diffuser 54 and discharged from apertures 56. Advantageously, the exemplary welding torch 12 includes a nozzle 58 that is threaded onto the diffuser 54 and that focuses egressing shielding gas towards the weld location. Additionally, the diffuser 54 receives current and wire electrode wire from the inner tube 50, and these resources are directed to a contact tip 60 that is seated with respect to the diffuser 54.

The contact tip 60 is configured to electrically communicate with wire electrode extending therethrough and egressing therefrom. In other words, the exemplary contact tip 60 includes an axial channel that is only slightly larger in diameter than the wire electrode. Accordingly, the contact tip 60 comes into contact with the wire electrode, energizing the wire electrode emerging from the contact tip 60, thereby facilitating arcing between the wire electrode and the workpiece 14 (FIG. 1) and, in turn, welding of the workpiece 14.

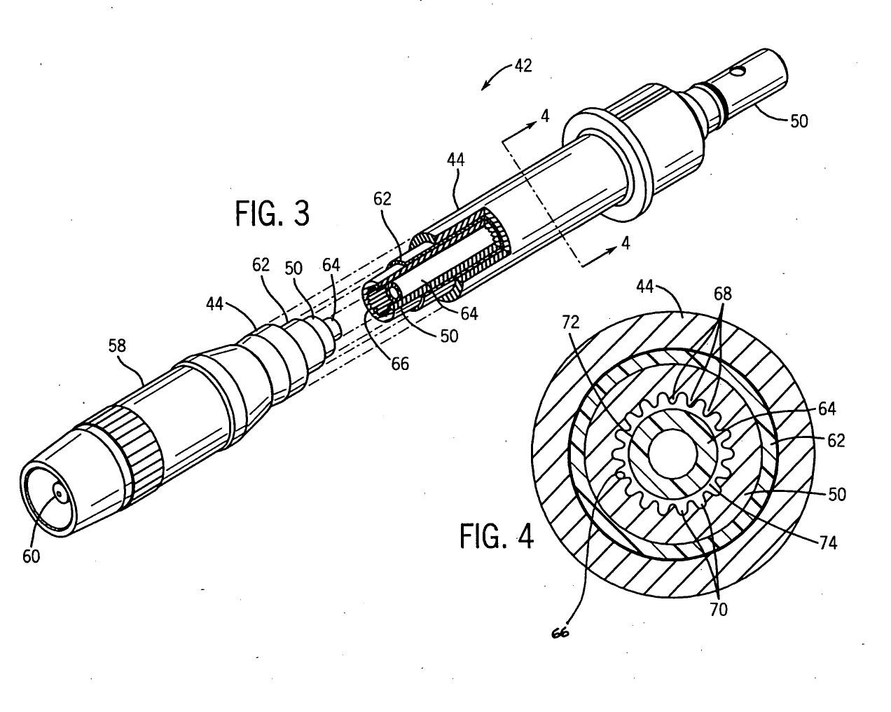

Turing to FIGS. 3 and 4, these figures illustrate various internal components of the above-described, exemplary neck assembly 42. As discussed above, this neck assembly 42 includes a first hollow member (i.e., outer tube 44) that defines much of the outer surface of the neck assembly 42. Disposed within the outer tube 44 (i.e., radially inboard of the outer tube 44) is a second hollow member, namely the inner tube 50. Advantageously, to improve the dissipation of heat in the welding torch, as discussed further below, the inner tube 50 is formed of materials with good thermal conductance, such as copper or brass. Additionally, as discussed further below, the exemplary neck assembly 42 includes a dielectric layer 62 that electrically isolates the inner tube 50 from the outer tube 44. By way of example, the dielectric layer 62 is a hollow third member that is formed of a polymeric material and that is press-fitted between the inner tube 50 and the outer tube 44. Furthermore, the neck assembly 42 includes a fourth hollow member, an electrode sleeve or liner 64 that is disposed within the inner tube 50.

During operation, electrical current, shielding gas, and welding electrode are routed from their respective sources to the neck assembly 42 via the welding cable 18. More specifically, the welding cable 18 feeds these resources to the neck assembly 42 via the cable nipple 38, which, again, mechanically couples the welding cable 18 to the neck assembly 42.

For example, welding electrode is routed from the welding cable 18 to the electrode liner or sleeve 64. More particularly, welding electrode is threaded into the interior region of the hollow sleeve 64. Advantageously, the sleeve 64 acts as a guide, directing the wire electrode through the neck assembly 42. The sleeve 64 may be formed of steel; however, in the illustrated neck assembly 42, the sleeve 64 is formed of an electrically insulative material, such as plastic. Accordingly, the plastic sleeve 64 prevents electrical communication between the inner tube 50 and the electrode prior to contact between the electrode and the contact tip 60. In other words, although the inner tube 50 is electrically energized, current is not conducted to the wire electrode routed therethrough.

Rather, electrical current from welding cable 18 is conducted through the inner tube 50 and into the diffuser 54, the contact tip 60 (FIG. 2), and, in turn, the wire electrode. In the present neck assembly 42, these electrically active components for conducting current to the wire electrode are formed of materials with good electrical conductivity, such as copper or brass. Again, the dielectric layer 62 electrically isolates the outer tube 44 from the inner tube 50, preventing electrical current from reaching the exposed surfaces of the outer tube 44. As an alternative design, the outer tube 44 may be formed of an electrically non-conductive material, for example, mitigating the need for the dielectric layer 62.

To improve cooling within the neck assembly 42, the inner tube 50 has a plurality of protrusions or ribs 68 that extend from the inner tube's 50 inner surface 66 along the length of the inner tube 50. In the exemplary neck assembly 42, the illustrated protrusions 68 that axially extend from the inner surface 66 and that generally extend in the direction of the longitudinal axis of the neck assembly 42 represent these protrusions 68. As best illustrated in FIG. 4, adjacent protrusions 68 at least partially define passageways 70 that generally extend in the direction of the longitudinal axis of the neck assembly 42. Advantageously, these protrusions 68 increase the surface area of the inner tube 50, improving, in turn, the efficacy of convective cooling of the inner tube 50, for instance.

These protrusions 68 may be formed via a number of processes. As one example, the illustrated protrusions 68 may be formed by an extrusion process, in which a form is forced through the inner tube 50, shaping the malleable material of the inner tube 50, thereby creating flutes or grooves between the protrusions 68. Alternatively, these protrusions 68 also may be formed via a casting process, for example. Indeed, a wide variety of fabrication techniques can be employed to produce protrusions having a myriad of shapes.

During operation, electrical current traversing through the inner tube 50 causes resistive heating of the inner tube 50. This heat, unfortunately, can negatively impact the wire electrode and, more generally, can negatively impact the performance of the welding torch. Indeed, oscillating between periods of heating and cooling within the torch assembly can cause unwanted expansion and contraction in various components, leading to premature failure, for instance. Advantageously, the protrusions 68 on the inner surface 66 of the inner tube 50 increase the square centimeters of exposed area of the inner tube 50, thereby facilitating an increase in the amount of heat dissipated from the inner tube 50 to the surrounding environment. In comparison to a smooth inner surface of a traditional welding device, the illustrated ribs 68 nearly double the surface area of inner surface 66. That is, the surface area of the illustrated inner surface 66 is greater than if the inner surface had a circular cross-section taken transverse to the longitudinal axis of the inner tube 50. These protrusions 68 facilitate an increase in the amount of heat dissipated into the environment by an amount believed to be seven percent. Indeed, the protrusions 68 act as radial fins for the dissipation of heat. Moreover, as discussed further below, if a shielding gas travels over the protrusions 68, the amount of heat dissipated may increase even further.

As mentioned above, the inner tube 50 also receives the shielding gas from the welding cable 18. Specifically, shielding gas is routed from the cable 18 and into the interior region of the hollow inner tube 50. However, this interior region also carries the electrode liner or sleeve 64. Accordingly, shielding gas is routed through the neck assembly 42 in the area defined by the inner surface 66 of the inner tube 50 and the outer surface 72 of the electrode sleeve 64. This region is best illustrated as gas-flow region 74 in FIG. 4. Advantageously, the illustrated protrusions 68, as discussed above, increase the surface area over which the shielding gas flows, improving, in turn, the cooling effect of the moving gas flow.

As another advantage, the protrusions 68 beneficially influence the flow of shielding gas through the inner tube 50. For example, the protrusions 68 also disrupt the flow of the shielding gas through the inner tube 50. That is to say, the protrusions 68 effectuate turbulence within the gas flow. This turbulence is believed to increase the cooling effect of the moving gas and, further, is believed to provide for a more even flow and egress of shielding gas with respect to the neck assembly 42 and the diffuser 54.

Additionally, the protrusions 68 prevent the electrode sleeve 64 from resting directly against an entire sections of the inner surface 66 of the inner tube 50, mitigating the likelihood of cooling shielding gas not contacting such sections. That is to say, adjacent protrusions 68 at least partially define passageways 70 through which shielding gas may flow. And the post-like nature of the protrusions 68 prevents the electrode sleeve 64 from closing off these passageways 70, increasing the likelihood of even flow of shielding gas through the inner tube 50. Indeed, each protrusion 68 has a peak against which the sleeve 64 rests. Because the peak prevents abutment of the sleeve 64 with portions of the inner surface 66, the peak at least partially defines interstices through which cooling fluid flows. As illustrated, adjacent protrusions 68 define interstices that extend the length of the inner tube and through which shielding gas is routed.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding torch for use with a wire electrode source and a contact tip, comprising:
a neck assembly configured to guide wire electrode toward the contact tip, the neck assembly comprising a hollow member having a plurality of protrusions that at least partially define passageways that extend in the direction of a longitudinal axis of the hollow member.

2. The welding torch as recited in claim 1, wherein the hollow member is configured to conduct electrical current from an electrical current source to the contact tip.

3. The welding torch as recited in claim 1, wherein the plurality of protrusions are disposed on an interior surface of the hollow member.

4. The welding torch as recited in claim 1, comprising a first end opposite to the contact tip and configured to be in fluid communication with a fluid source, wherein the hollow member is configured to route fluid from the fluid source therethrough and toward the contact tip.

5. The welding torch as recited in claim 4, comprising a sleeve disposed radially inboard of the hollow member, wherein the hollow member and an exterior surface of the sleeve define the passageways for the communication of fluid.

6. The welding torch as recited in claim 5, comprising an electrically insulative hollow member disposed radially outboard of the hollow member.

7. A welding torch through which a wire electrode is payed out, the welding torch comprising:
a liner having an outside diameter and an inside diameter, the inside diameter at least partially defining an interior volume directed along a length of the liner, wherein the wire electrode is routed through the interior volume; and
a tube having an inside peripheral surface, the outside diameter of the liner being located radially within the inside peripheral surface of the tube, the inside peripheral surface having a surface area that is greater than if the inside peripheral surface were circular in a cross-section transverse to a longitudinal axis of the tube.

8. The welding torch as recited in claim 7, wherein the inside peripheral surface includes a protrusion.

9. The welding torch as recited in claim 8, wherein the inside peripheral surface includes a plurality of protrusions.

10. The welding torch as recited in claim 9, wherein the protrusions each extend along the length of the tube.

11. The welding torch as recited in claim 9, wherein the protrusions terminate in respective peaks, the peaks abutting against the outside diameter of the liner, and wherein adjacent peaks at least partially define interstices for fluid communication therebetween.

12. The welding torch as recited in claim 7, wherein the tube comprises copper.

13. The welding torch as recited in claim 7, wherein the tube comprises brass.

14. A welding system having an electrical current source and a wire electrode source, comprising:
a welding cable electrically coupleable to the electrical current source and configured to receive wire electrode from the wire electrode source; and
a welding torch coupleable to the welding cable and configured to receive electrical current and wire electrode therefrom, the welding torch comprising a hollow member through which wire electrode is routed, the hollow member having a plurality of protrusions extending from an interior surface thereof.

15. The welding system as recited in claim 14, comprising a fluid source, wherein the welding torch is configured to receive fluid from the fluid source via the welding cable, such that fluid is routed between the plurality of protrusions of the hollow member.

16. The welding system as recited in claim 15, comprising a sleeve disposed radially inboard of the hollow member, such that fluid is routed through the welding torch between the hollow member and the sleeve.

17. The welding system as recited in claim 14, wherein the hollow member is electrically coupleable to the electrical current source.

18. The welding system as recited in claim 14, comprising a dielectric material circumferentially surrounding the hollow member.

19. The welding system as recited in claim 14, wherein the plurality of protrusions comprises a plurality of ribs that extend generally in a direction of a longitudinal axis of the hollow member.

20. A tube for a welding torch within which a wire electrode liner may be nested, the tube having an inside circumferential surface that includes protrusions extending inwardly therefrom, each of the protrusions terminating in respective peaks, the peaks being sized to abut against the wire electrode liner.

21. The tube recited in claim 20, wherein the tube comprises copper.

22. The tube recited in claim 20, wherein the tube comprises brass.
